(19) United States
(12) Patent Application Publication
(10) Pub. No.: US 2024/0066661 A1
(43) Pub. Date: Feb. 29, 2024

(54) METHOD FOR MANUFACTURING A POLISHING SHEET AND A POLISHING PAD

(71) Applicant: SK enpulse Co., Ltd., Gyeonggi-do (KR)

(72) Inventors: Joonho AN, Gyeonggi-do (KR); Jangwon SEO, Gyeonggi-do (KR); Chang Gyu IM, Gyeonggi-do (KR); Jong Wook YUN, Gyeonggi-do (KR); Kyung Hwan KIM, Gyeonggi-do (KR)

(21) Appl. No.: 18/361,910

(22) Filed: Jul. 31, 2023

(30) Foreign Application Priority Data
Aug. 26, 2022 (KR) 10-2022-0107567

(51) Int. Cl. B24B 37/26; B29C 48/00; B29C 48/08; B29C 48/91; C08J 5/18

(52) U.S. Cl. CPC B24B 37/26; B29C 48/0011; B29C 48/0019; B29C 48/002; B29C 48/0022; B29C 48/08; B29C 48/91; C08J 5/18; B29L 2031/736

(57) ABSTRACT

The embodiments provide a process for preparing a polishing sheet, a polishing pad using the same, and a process for preparing a semiconductor device using the same. The process for preparing a polishing sheet comprises forming a pattern on the surface of a polymer sheet and winding the patterned polymer sheet to form a wound roll in a cylindrical shape. Thus, there are great advantages in that it is possible to control the size and distribution ratio of a fine and uniform pattern at a desired location in an economical and efficient way and to freely design the type, size, structure, physical properties, and the like of the polishing sheet according to the purpose, whereby the application field can be expanded, and a bulk structure can be manufactured.

### CROSS-REFERENCE TO RELATED APPLICATIONS

The present application claims the benefit of priority under 35 U.S.C. § 119(a) to Korean Patent Application No. 10-2022-0107567, filed on Aug. 26, 2022, which is incorporated herein by reference in its entirety.

### TECHNICAL FIELD

The present invention relates to a process for preparing a polishing sheet to be applied to a polishing process. It relates to a technique of preparing a polishing pad using a polishing sheet formed by the above process and applying the polishing pad to a process for preparing a semiconductor device.

### BACKGROUND ART

A chemical mechanical planarization (CMP) or chemical mechanical polishing (CMP) process may be carried out for various purposes in various technical fields. The CMP process is carried out on a certain side of an object to be polished. It may be carried out for the purposes of planarization of the side to be polished, removal of aggregated materials, resolution of damage to the crystal lattice, and removal of scratches and contamination sources.

A polishing pad is an essential member that plays an important role in such a CMP process. In general, it is composed of a polyurethane-based resin and has pores for supporting the flow of a slurry.

In general, pores in a polishing pad are formed using, for example, a solid phase foaming agent, a liquid substance that generates gas by a chemical reaction, or an inert gas. Open pores formed on the surface of a polishing pad serve to support the fine flow of a slurry and to enhance polishing performance. In addition, the pores are deformed by compressive force and shear force applied in a CMP process or contain foreign substances. In order to restore the gradual deterioration of the surface state of a polishing pad during a CMP process through the above procedure, a conditioning process of cutting the surface of the polishing layer with a diamond disk or the like is also performed.

However, the above method may cause the condensation of gas in the pores immediately after the reaction and make it difficult to form a fine pore structure or have many limitations. There may be limitations in controlling the pores to have uniform size distribution and ratio. As a result, various problems may arise during a CMP process: for example, the polishing performance is impaired, the lifespan of the polishing pad is shortened, and the capability to manufacture high-quality semiconductor devices is limited.

### PRIOR ART DOCUMENT

(Patent Document 1) Korean Patent No. 10-1608901

### DISCLOSURE OF INVENTION

### Technical Problem

The present invention is devised to solve the above problems of the prior art.

A technical problem to be solved by the present invention is to provide a process for preparing a polishing sheet in an economical and efficient manner, in which fine and uniform patterns can be formed at a desired location, and their size and distribution ratio can be controlled.

In addition, it is to provide a process for preparing a polishing pad using a polishing sheet prepared by the above preparation process and, further, a process for preparing a semiconductor device capable of enhancing productivity and processability as well as achieving excellent physical properties using the polishing pad.

### Solution to Problem

In an embodiment of the present invention, there is provided a process for preparing a polishing sheet, which comprises (1) preparing a polymer sheet comprising a polymer resin; (2) forming a pattern on the surface of the polymer sheet; (3) winding the patterned polymer sheet to form a wound roll in a cylindrical shape; and (4) cutting the wound roll in a direction perpendicular to the center line.

In another embodiment of the present invention, there is provided a process for preparing a polishing pad, which comprises providing a polishing sheet; and forming a cushion layer on one side of a polishing layer comprising the polishing sheet, wherein the step of providing a polishing sheet comprises (1) preparing a polymer sheet comprising a polymer resin; (2) forming a pattern on the surface of the polymer sheet; (3) winding the patterned polymer sheet to form a wound roll in a cylindrical shape; and (4) cutting the wound roll in a direction perpendicular to the center line.

### Advantageous Effects of Invention

The process for preparing a polishing sheet according to the embodiment comprises the steps of forming a pattern on the surface of a polymer sheet and winding the patterned polymer sheet to form a wound roll in a cylindrical shape. Thus, there are great advantages in that it is possible to control the size and distribution ratio of a fine and uniform pattern at a desired location in an economical and efficient way, to freely and partially adjust the physical properties of the polishing sheet by varying the composition for each part of the polishing sheet, and to freely adjust the polishing rate by virtue of the variation in the physical properties of each part. In addition, the size and distribution of a pattern can be maintained uniformly by cutting the wound roll in a cylindrical shape in a direction perpendicular to the center line. Thus, it is possible to further enhance the lifespan characteristics and physical properties of a polishing pad prepared therefrom.

Further, in the process for preparing a polishing sheet, not only the formation of the fine and uniform pattern, but also the composition, type, size, structure, and physical properties of the polishing sheet can be partially or entirely designed freely according to the purpose, whereby the application field can be expanded. There are great advantages in terms of productivity and processability in that it is possible to manufacture a bulk structure.

### BRIEF DESCRIPTION OF DRAWINGS

FIG. 1 schematically illustrates the process for preparing a polishing sheet according to an embodiment.

FIG. 2 schematically illustrates a process flow diagram for preparing a polishing sheet using punching rollers according to an embodiment.

FIG. 3 schematically illustrates an enlarged view of a method of forming a pattern by punching rollers in the process flow diagram of FIG. 2.

FIG. 4 schematically illustrates a process flow diagram for preparing a polishing sheet using a laser pulse according to another embodiment.

FIG. 5 schematically illustrates an enlarged view of a method of forming a pattern by a laser pulse in the process flow diagram of FIG. 4.

FIG. 6(a) is a perspective view schematically showing a wound roll on which an induced pattern is formed, and FIG. 6(b) schematically illustrates a method of cutting a wound roll into the shape of polishing sheets, in the process for preparing a polishing sheet according to an embodiment.

FIG. 7 schematically illustrates a cross-sectional view of a polishing sheet prepared using the punching rollers of FIG. 3.

FIG. 8 schematically illustrates a cross-sectional view of a polishing sheet prepared using the laser pulse of FIG. 5.

FIG. 9 shows a cross-sectional view of a polishing pad comprising a polishing layer comprising a polishing sheet according to an embodiment and a cushion layer.

FIG. 10 schematically illustrates the process for preparing a semiconductor device according to an embodiment.

### REFERENCE NUMERALS OF THE DRAWINGS

(a): synthesis tank, (b-1): first rollers, (b-2): second rollers, (b-3): third rollers,
(h-1): first thermal treatment (first-second thermal treatment),
(h-2): second thermal treatment, (h-3): third thermal treatment,
10: polymer sheet, 20: punching rollers, 30: laser pulse, 50: wound roll,
60: pattern (first pattern), 80: induced pattern (second pattern),
100: polishing pad, 200: polishing sheet, 250: polishing layer,
350: cushion layer, 420: platen, 430: semiconductor substrate, 440: nozzle,
450: polishing slurry, 460: polishing head, 470: conditioner, C: center line,
V: perpendicular direction to the center line.

### BEST MODE FOR CARRYING OUT THE INVENTION

The advantages and features of the present invention and methods for achieving the same will become apparent with reference to the following embodiments. However, the present invention is not limited to the embodiments disclosed below, and it will be implemented in a variety of different forms. These embodiments allow the disclosure of the present invention to be complete, and to fully inform a person of ordinary skill in the art to which the present invention pertains of the scope of the invention. The present invention is only defined by the scope of the claims.

Throughout the present specification, when a part is referred to as “comprising” an element, it is understood that other elements may be comprised, rather than other elements are excluded, unless specifically stated otherwise.

All numbers and expressions related to the quantities of components, reaction conditions, and the like used herein are to be understood as being modified by the term “about,” unless otherwise indicated.

In the present specification, in the case where an element is mentioned to be formed “on” or “under” another element, it means not only that one element is directly formed “on” or “under” another element, but also that one element is indirectly formed on or under another element with other element(s) interposed between them.

In addition, the term “side” or “on” or “under” with respect to each element may be referenced to the drawings. These terms are only for distinguishing the components and can be interchanged with each other in actual application.

Throughout the present specification, the terms first, second, and the like are used to describe various components. But the components should not be limited by the terms. The terms are used for the purpose of distinguishing one element from another.

In addition, for the sake of description, the sizes of individual elements in the appended drawings may be exaggeratedly depicted and do not indicate the actual sizes. In addition, the same reference numerals refer to the same elements throughout the present specification.

[Process for Preparing a Polishing Sheet]

In an embodiment according to the present invention, there is provided a process for preparing a polishing sheet, which comprises (1) preparing a polymer sheet comprising a polymer resin (step (1), S110); (2) forming a pattern on the surface of the polymer sheet (step (12), S120); (3) winding the patterned polymer sheet to form a wound roll in a cylindrical shape (step (3), S130); and (4) cutting the wound roll in a direction perpendicular to the center line (step (4), S140).

The process for preparing a polishing sheet according to an embodiment of the present invention comprises the above steps (1) to (4). In particular, it comprises the steps of forming a pattern on the surface of a polymer sheet, winding the patterned polymer sheet to form a wound roll in a cylindrical shape, and cutting the same in a direction perpendicular to the center line. Thus, it is possible to control the size and distribution ratio of a fine and uniform pattern at a desired location in an economical and efficient way, to freely and partially adjust the physical properties of the polishing sheet by varying the composition for each part of the polishing sheet, to freely adjust the polishing rate by virtue of the variation in the physical properties of each part, and to further enhance the lifespan characteristics and physical properties of a polishing pad prepared therefrom. In particular, the process for preparing a polishing sheet has technical significance in that it is possible to partially or entirely design the composition, type, size, structure, physical properties, and the like of the polishing sheet freely according to the purpose, and it has an advantage in terms of productivity and processability since a bulk structure can be manufactured.

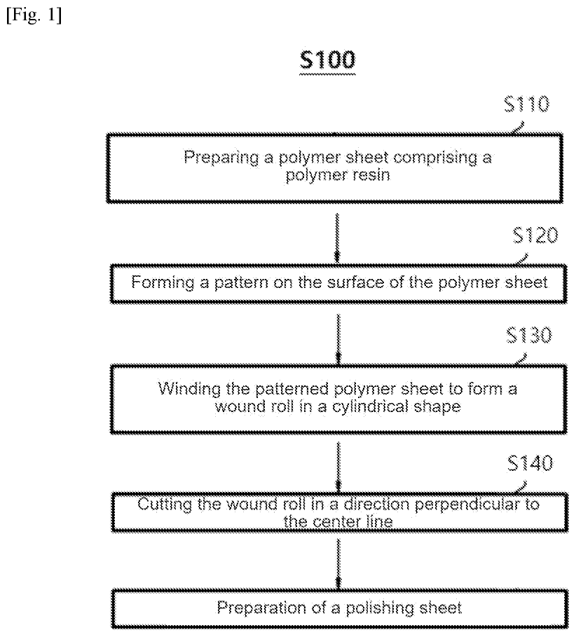

Hereinafter, the process for preparing a polishing sheet according to an embodiment of the present invention will be described in detail with reference to FIGS. 1, 2, and 4.

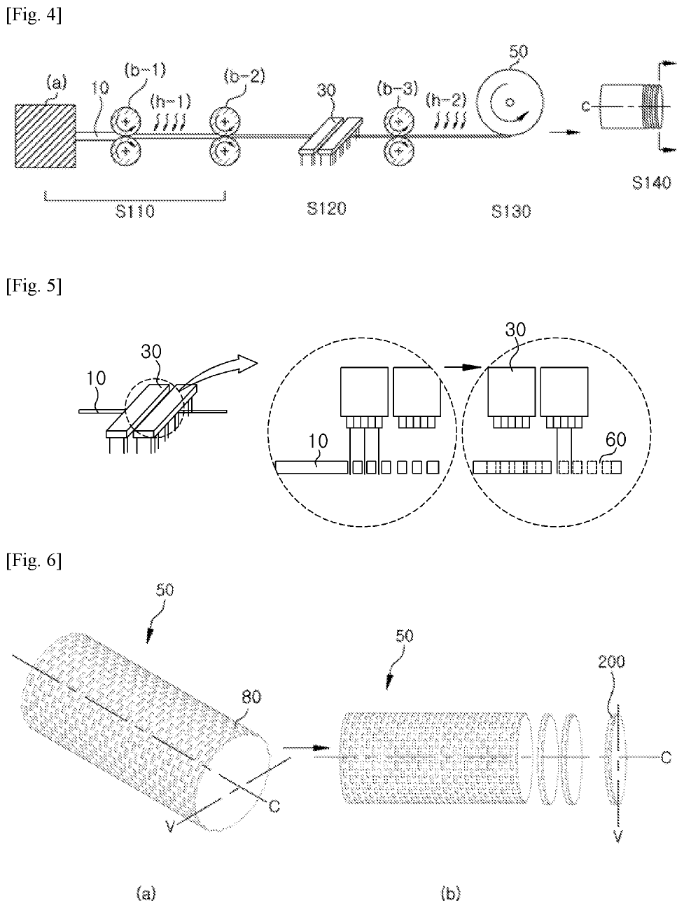

FIG. 1 schematically illustrates the process for preparing a polishing sheet according to an embodiment. In addition, FIG. 2 schematically illustrates a process flow diagram for preparing a polishing sheet using punching rollers according to an embodiment. FIG. 4 schematically illustrates a process flow diagram for preparing a polishing sheet using a laser pulse according to another embodiment.

Hereinafter, each step of the process for preparing a polishing sheet will be described in detail with reference to FIGS. 1, 2, and 4.

S110: Step of preparing a polymer sheet First, referring to FIG. 1, in the process for preparing a polishing sheet (S100), step (1) is a step of preparing a polymer sheet comprising a polymer resin (S110).

The polymer resin may comprise various polymer resins as long as the effect of the present invention is not impaired.

Specifically, the polymer resin may comprise a thermoplastic polymer resin. For example, the thermoplastic polymer resin may comprise at least one selected from the group consisting of polyurethane-based resins, polyethylene-based resins, polypropylene-based resins, polystyrene-based resins, acrylic-based resins, vinylidene chloride-based resins, vinyl chloride-based resins, fluorine-based resins, polyvinyl acetate-based resins, polyamide-based resins, polycarbonate-based resins, acetal-based resins, polyphenylene oxide-based resins, polyester-based resins, polysulfone-based resins, and polyimide-based resins.

If the polymer resin comprises the thermoplastic polymer resin of the above type, it is easy to process to form a pattern in the process for preparing a polishing sheet; the adhesive strength between the surfaces of the polymer resin is excellent during winding, which makes winding easy; and it may be very advantageous for preparing a bulk structure.

In addition, when the polymer sheet is prepared, there is a great advantage in that it is possible to implement different physical properties for each part of the polymer sheet by flowing a composition having different components into a resin synthesis tank and to freely adjust the polishing rate by virtue of the variation in the physical properties for each part.

According to an embodiment of the present invention, the preparation of a polymer sheet (S110) may comprise (1-1) heating and melting the polymer resin; (1-2) extruding the molten polymer resin to form a sheet; and (1-3) adjusting the thickness of the sheet at least once using rollers.

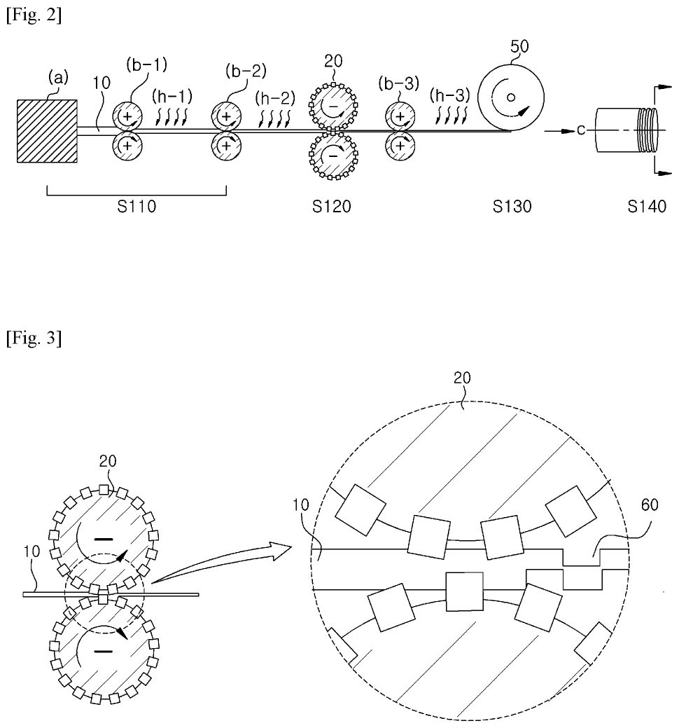

Specifically, step (1-1) may be a step of heating and melting the polymer resin. Referring to FIGS. 2 and 3, the main raw material in a solid state based on the polymer resin may be fed to a synthesis tank (a), and the polymer resin may be heated and melted to be converted into a flowable liquid state.

The heating may be carried out at a temperature higher than the melting temperature (Tm) of the polymer resin. Specifically, the heating may be carried out at a temperature higher than the melting temperature (Tm) of the polymer resin, for example, 180° C. to 350° C.

According to an embodiment of the present invention, when heated at 180° C. to 350° C., it may be converted into a flowable liquid state having a low viscosity of 5 to 10 g/10 minutes as measured at 190° C. (under a load condition of about 2 kg) to obtain a molten polymer resin. The viscosity may be measured using a DVE-RV viscometer that utilizes shear stress to measure viscosity.

Step (1-2) may be a step of extruding the molten polymer resin and molding it into a sheet form.

The molten polymer resin may be molded into a thin sheet form using, for example, an extrusion molding machine. A commonly used extrusion molding machine may be used as the extrusion molding machine without limitation. The size and thickness of the sheet may be freely selected according to a desired purpose during the molding.

Referring to FIGS. 2 and 4, step (1-3) may comprise adjusting the thickness of the sheet at least once using rollers ((b-1) and (b-2)).

The rollers ((b-1) and (b-2)) are those for adjusting the thickness of the sheet, and the thickness of the sheet obtained in step (1-2) can be adjusted using the rollers. In addition, the sheet can be adjusted to a desired thickness by setting the gap between the rollers.

The thickness of the sheet adjusted using the rollers ((b-1) and (b-2)) may be a factor for adjusting the width of a pattern (e.g., irregularities, grooves, pores, or penetrating holes) applied in the subsequent process or the spacing with which the pattern is formed.

Adjusting the thickness of the sheet may be carried out at least once or more according to a desired pattern design using the rollers. Specifically, it may be carried out once, twice, or more.

For example, in the case where the thickness adjustment is carried out once, the rollers may comprise first rollers ((b-1)).

In the case where the thickness adjustment is carried out twice, the rollers may comprise first rollers ((b-1)) and second rollers ((b-2)). That is, the thickness can be adjusted using the first rollers ((b-1)), and the thickness uniformity of each part of the sheet can be optimized by using the second rollers ((b-2)).

In order to optimize the thickness uniformity of the sheet, the rollers ((b-1) and (b-2)) may be swept left and right while rotating.

Meanwhile, in step (1-3), in order to further facilitate the thickness control of the sheet and to form a uniform thickness distribution of the sheet to be molded, a step of subjecting the sheet to a first thermal treatment at a temperature between the melting temperature (Tm) and the glass transition temperature (Tg) of the polymer resin may be further carried out before the use of the rollers.

Specifically, immediately before the sheet is introduced to the rollers, a thermal treatment is carried out at least once using, for example, a heater at a temperature between the melting temperature (Tm) and the glass transition temperature (Tg) of the polymer resin.

As an example, the molded sheet obtained in step (1-2) is subjected to a first thermal treatment at a temperature between the melting temperature (Tm) and the glass transition temperature (Tg) of the polymer resin, and the first rollers ((b-1)) are used to adjust the thickness thereof.

Referring back to FIGS. 2 and 4, as another example, the molded sheet obtained in step (1-2) may be subjected to thickness adjustment, without thermal treatment, which is then subjected to a first thermal treatment ((h-1)) at a temperature between the melting temperature (Tm) and the glass transition temperature (Tg) of the polymer resin. As another example, the molded sheet obtained in step (1-2) is subjected to a first-first thermal treatment at a temperature between the melting temperature (Tm) and the glass transition temperature (Tg) of the polymer resin, the first rollers ((b-1)) are used to adjust the thickness thereof. Then, it is subjected to a first-second thermal treatment ((h-1)) at the above temperature, and the second rollers ((b-2)) are used to optimize the thickness uniformity thereof.

In the case where rollers are used after the thermal treatment, it may be more advantageous for more easily controlling the thickness and obtaining a desired uniform thickness.

S120: Step of Forming a Pattern (First Pattern) on the Surface of the Polymer Sheet

Referring back to FIG. 1, in the process for preparing a polishing sheet (S100), step (2) is a step of forming a pattern (first pattern) on the surface of the polymer sheet (S120).

In step (2), forming a pattern (first pattern) may comprise a step of forming irregularities, grooves, pores, or penetrating holes.

The pattern (first pattern) can be freely designed and adjusted in size, spacing, location, shape, and the like according to a desired purpose.

The pattern (first pattern) of the irregularities, grooves, pores, or penetrating holes may be formed using, for example, a punching roller, a laser pulse, or both.

FIG. 3 schematically illustrates an enlarged view of a method of forming a pattern (first pattern) (60) on the surface of a polymer sheet (1) by punching rollers (20) in the process flow diagram of FIG. 2.

A desired size, spacing, height (depth), location, shape, and the like may be designed to form a pattern (first pattern) (60) on the surface of the polymer sheet (10), such as irregularities, grooves, pores, or penetrating holes using the punching rollers (20).

As shown in FIG. 3, the punching rollers (20) provided with a main punching roller and an auxiliary punching roller may be used to form a pattern on both sides of the polymer sheet (1).

For example, the polymer sheet (10) prepared in step (1) may be introduced between the punching rollers (20) in step (2) to form a pattern (first pattern) (60) on the surface of the polymer sheet (10), such as irregularities, grooves, pores, or penetrating holes.

In addition, the punching rollers (20) may be provided with a main punching roller alone to form a pattern (first pattern) on one side of the polymer sheet (1). Various punching rollers may be used as the punching rollers (20) depending on the shape of a desired pattern, but they are not limited thereto.

Meanwhile, referring back to FIG. 2, in step (2), a step of subjecting the sheet to a second thermal treatment ((h-2)) at a temperature between the melting temperature (Tm) and the glass transition temperature (Tg) of the polymer resin may be further carried out before the formation of a pattern (first pattern).

Specifically, when the punching rollers are used, a second thermal treatment ((h-2)) of the polymer sheet (10) prepared in step (1) may be carried out, before the punching rollers (20) are used in step (2), using, for example, a heater at a temperature between the melting temperature (Tm) and the glass transition temperature (Tg) of the polymer resin. In such a case, the process of forming a pattern (first pattern) may be more easily carried out, and it may be advantageous for forming a uniform pattern.

The size and spacing of the pattern (first pattern) are determined by the size and spacing of irregularities on the surface of the punching rollers. The shape, size, height (depth), and spacing of the irregularities on the surface of the punching rollers may be differently adapted depending on the design purpose of the pattern (first pattern) to be formed.

For example, the punching rollers comprise irregularities on the surface to form the pattern (first pattern). The surface irregularities of the punching roller may have a diameter of 100 μm or less, for example, 1 to 100 μm, a height of 50 μm or less, for example, 1 to 50 μm, and a spacing therebetween of 50 μm or less, for example, 1 to 50 μm.

FIG. 4 schematically illustrates a process of forming a pattern (first pattern) by a laser pulse (30) according to another embodiment of the present invention. A desired size, spacing, location, shape, and the like may be designed to form a pattern (first pattern), for example, pores (holes), using the laser pulse.

When the laser pulse is used, a laser beam is irradiated on the surface of the polymer sheet having an adjusted thickness to melt the surface of the polymer sheet, whereby a fine pattern (first pattern), for example, pores (holes), may be formed.

FIG. 5 schematically illustrates an enlarged view of a method of forming a pattern (first pattern) (60) on the surface of a polymer sheet (1) by laser pulse (30) in the process flow diagram of FIG. 4.

When the laser pulse is used, the step of thermally treating the polymer sheet prepared in step (1) immediately before using the laser pulse in step (2) is not necessary and can be omitted. The size and spacing of a pattern formed on the surface of the sheet can be freely adjusted by adjusting the frequency (laser oscillation number/time) of applied laser pulses, the distance between laser oscillation entrances, and the diameter of a laser spot.

According to an embodiment of the present invention, if a pattern (first pattern) is formed using the punching rollers (20) and the laser pulse (30), there is a great advantage in that a uniform pattern can be freely achieved according to the purpose.

S130: Step of Winding the Polymer Sheet to Form a Wound Roll in a Cylindrical Shape

Referring back to FIG. 1, in the process for preparing a polishing sheet (S100), step (3) is a step of winding the polymer sheet on which a pattern (first pattern) has been formed to form a wound roll in a cylindrical shape (S130).

As the polymer sheet on which a pattern (first pattern) has been formed is wound to form a wound roll, it is possible to manufacture a bulk structure in an economical and efficient way, and it is very advantageous in terms of productivity and processability. Further, the type, size, structure, and physical properties of a polishing sheet can be freely designed according to the purpose.

According to an embodiment of the present invention, in step (3), before the polymer sheet on which a pattern (first pattern) has been formed is wound, a step of adjusting the thickness of the polymer sheet on which a pattern (first pattern) has been formed using rollers may be further carried out.

Specifically, referring back to FIG. 2, the thickness of the polymer sheet on which a pattern (first pattern) has been formed as obtained in step (2) may be adjusted using third rollers ((b-3)), and the polymer sheet whose thickness has been adjusted with a pattern (first pattern) formed thereon is then would to form a wound roll (50).

In addition, after the thickness is adjusted using the third rollers ((b-3)), a step of gelating the polymer sheet may be further carried out before the polymer sheet on which a pattern (first pattern) has been formed is wound.

The gelation may be carried out by a third thermal treatment ((h-3)) at a temperature between the melting temperature (Tm) and the glass transition temperature (Tg) of the polymer resin.

Specifically, according to an embodiment of the present invention, as the polymer sheet on which a pattern (first pattern) has been formed is subjected to a third thermal treatment ((h-3)) at a temperature between the melting temperature (Tm) and glass transition temperature (Tg) of the polymer resin by, for example, using a heater, before the polymer sheet on which a pattern (first pattern) has been formed is wound, the surface of the polymer sheet on which a pattern (first pattern) has been formed is gelated, which is wound into a roll shape and fixed in the form of a bulk structure to obtain a wound roll (50).

Likewise, referring to FIG. 4, when a laser pulse is used, after the thickness is adjusted using the third rollers ((b-3)), a step of gelating the polymer sheet may be further carried out before the polymer sheet on which a pattern (first pattern) has been formed is wound. In such a case, the gelation may be carried out by a second thermal treatment ((h-2)) at a temperature between the melting temperature (Tm) and the glass transition temperature (Tg) of the polymer resin.

According to another embodiment of the present invention, before the polymer sheet on which a pattern (first pattern) has been formed is wound, an adhesive layer may be attached to one side of the polymer sheet, for example, the inside of the polymer sheet in the winding direction, or an adhesive spray may be injected, to be wound together. In such a case, the polymer sheet may be wound into a roll form and fixed in the form of a bulk structure to obtain a wound roll.

In such an event, commonly used resins, adhesives, and adhesive sprays that are easy to adhere can be used as the adhesive layer and adhesive spray as long as they do not impair the effects of the present invention.

In addition, a step of subjecting the wound roll (50) in a cylindrical shape obtained in step (3) to a fourth thermal treatment (not shown) at a temperature equal to, or lower than, the melting temperature (Tm) of the polymer resin may be further carried out.

The fourth thermal treatment can optimize the adhesion between the polymer sheets and the physical properties of the wound roll, such as hardness, modulus, and crystallization of the wound roll.

S140: Step of cutting the wound roll in a direction perpendicular to the center line Referring back to FIG. 1, in the process for preparing a polishing sheet (S100), step (4) is a step of cutting the wound roll (50) in a direction (V) perpendicular to the center line (C) (S140).

In step (4), the cutting step may be carried out at room temperature using at least one selected from the group consisting of a diamond blade, a wire saw, and a multi wire saw.

The cutting step may be carried out by cutting sheets one by one or by forming a plurality of cut planes at once.

For example, it can be cut sheet by sheet using a diamond blade or a wire saw under room temperature conditions.

As another example, several sheets can be cut at once using a multi wire saw at room temperature such that a plurality of cut planes are formed at once.

FIG. 6(a) is a perspective view schematically showing a wound roll (50) on which an induced pattern (80) is formed, and FIG. 6(b) schematically illustrates a method of cutting a wound roll (50) into the shape of polishing sheets (200), in the process for preparing a polishing sheet according to an embodiment.

A polishing sheet prepared according to an embodiment of the present invention may have a circular longitudinal cross-section.

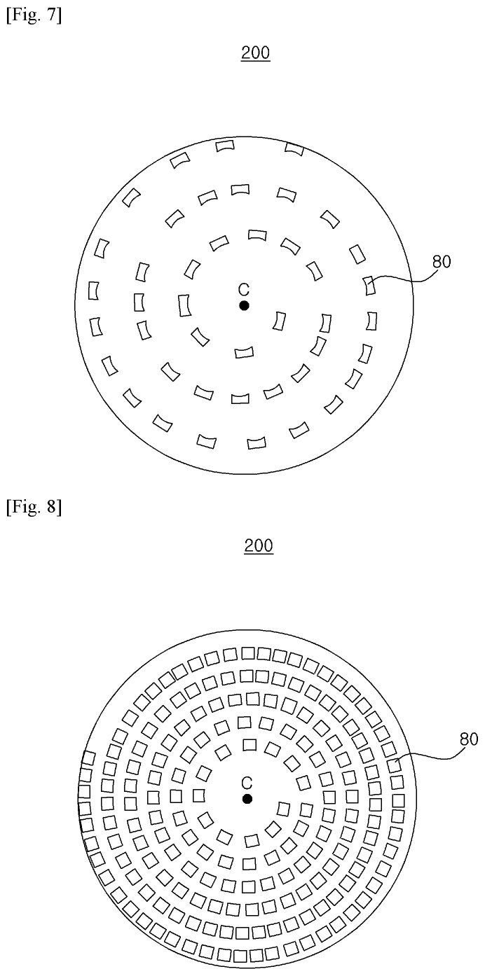

As an example, FIG. 7 schematically illustrates a cross-sectional view of a polishing sheet (200) prepared using the punching rollers (20) of FIG. 3.

Referring to FIG. 7, the polishing sheet (200) is formed with a pattern (80) induced on the surface as the polymer sheet on which the pattern has been formed is wound. The total area of the induced pattern (80) may be 20% or more, 30% or more, 40% or more, 50% or more, and may be 90% or less, 80% or less, or 70% or less, for example, 30% to 70% of the total surface area of the polishing sheet (200).

As another example, FIG. 8 schematically illustrates a cross-sectional view of a polishing sheet (200) prepared using the laser pulse of FIG. 5. Referring to FIG. 8, the polishing sheet (200) is formed with a pattern (80) on the induced surface as the polymer sheet on which the pattern has been formed is wound. The total area of the induced pattern may be 20% or more, 30% or more, 40% or more, 50% or more, and may be 90% or less, 80% or less, or 70% or less, for example, 30% to 70% of the total surface area of the polishing sheet.

In addition, the diameter of the polishing sheet may be adjusted by the diameter of the wound roll and may be variously modified according to a desired purpose. For example, the diameter of the polishing sheet may be 300 mm or more, 350 mm or more, 400 mm or more, 450 mm or more, or 500 mm or more. The diameter of the polishing sheet may be 800 mm or less, 750 mm or less, or 700 mm or less.

In addition, the thickness of the polishing sheet may be adjusted by the thickness of the wound roll to be cut and may be variously modified according to a desired purpose. The thickness of the polishing sheet may be 1.5 mm to 5 mm, 1.5 mm to 4.5 mm, 1.5 mm to 3.5 mm, 1.5 mm to 3 mm, 2 mm to 5 mm, 2.5 mm to 5 mm, or 3 mm to 5 mm.

In addition, the physical properties of the polishing sheet may be variously modified according to a desired purpose.

For example, the surface hardness of the polishing sheet at 25° C. may be 10 Shore D to 90 Shore D, 20 Shore D to 90 Shore D, 30 Shore D to 80 Shore D, 30 Shore D to 70 Shore D, or 40 Shore D to 70 Shore D, but it is not limited thereto. The surface hardness of the polishing sheet may be measured by, for example, cutting the polishing sheet into a size of 2 cm×2 cm (thickness: 2 mm), leaving it at a temperature of 25° C. for 16 hours, and then using a hardness tester (D-type hardness tester).

In an embodiment, the polishing sheet may have a circular longitudinal cross-section, a diameter of 300 mm or more, a thickness of 1.5 mm to 5 mm, and a hardness of 10 Shore D to 90 Shore D.

In addition, the polishing sheet may have a specific gravity of 0.6 g/cm³ to 0.9 g/cm³. More specifically, the polishing sheet may have a specific gravity of 0.7 g/cm³ to 0.85 g/cm³, but it is not limited thereto. The specific gravity of the polishing sheet may be measured by, for example, cutting the polishing sheet into a rectangle of 4 cm×8.5 cm (thickness: 2 mm), leaving it under the conditions of a temperature of 23±2° C. and a humidity of 50±5% for 16 hours, and using a hydrometer.

Specifically, the polishing sheet may have a tensile strength of 10 N/mm² to 100 N/mm². More specifically, the polishing sheet may have a tensile strength of 15 N/mm² to 70 N/mm². Even more specifically, the polishing sheet may have a tensile strength of 20 N/mm² to 70 N/mm², but it is not limited thereto. The tensile strength of the polishing sheet may be measured by, for example, cutting the polishing sheet into 4 cm×1 cm (thickness: 2 mm) and using a universal testing machine (UTM) to obtain the ultimate strength immediately before the fracture of the polishing sheet tested at a rate of 50 mm/minute.

Specifically, the polishing sheet may have an elongation of 30% to 300%. More specifically, the polishing sheet may have an elongation of 50% to 200%. The elongation of the polishing sheet may be measured by, for example, cutting the polishing sheet into 4 cm×1 cm (thickness: 2 mm) and using a universal testing machine (UTM) to obtain the maximum deformation immediately before the fracture of the polishing sheet tested at a rate of 50 mm/minute. The ratio of the maximum deformation to the initial length was expressed in percent (%).

As the polymer sheet on which a pattern (first pattern) has been formed is wound, an induced pattern (second pattern) may be formed on the surface (i.e., the vertical cross-section of the wound roll) of the polishing sheet. The total area of the induced pattern (second pattern) may be 30% to 70% of the total surface area of the polishing sheet.

Specifically, the polishing sheet may have a total area of the induced pattern (second pattern) (irregularities, grooves, pores, or penetrating holes induced by winding) formed on its surface of 20% or more, 30% or more, 40% or more, 50% or more, and 90% or less, 80% or less, or 70% or less, for example, 30% to 70%, 40% to 70%, 50% to 70%, 30% to 60%, or 45% to 65% of the total surface area of the polishing sheet.

According to an embodiment of the present invention, the physical properties of the polishing sheet are not limited to the above ranges. The composition, type, winding method, size, structure, and pattern shape of the polishing sheet may be partially or entirely modified to freely design according to a desired purpose.

[Process for Preparing a Polishing Pad]

According to an embodiment of the present invention, there is provided a process for preparing a polishing pad using the polishing sheet prepared by the above process.

The process for preparing a polishing pad according to an embodiment of the present invention comprises providing a polishing sheet; and forming a cushion layer on one side of a polishing layer comprising the polishing sheet, wherein the step of providing a polishing sheet comprises (1) preparing a polymer sheet comprising a polymer resin; (2) forming a pattern on the surface of the polymer sheet; (3) winding the patterned polymer sheet to form a wound roll in a cylindrical shape; and (4) cutting the wound roll in a direction perpendicular to the center line.

Each step of the process for preparing a polishing pad will be described in detail.

The process for preparing a polishing pad comprises providing a polishing sheet.

The process for preparing a polishing sheet is as described above.

The process for preparing a polishing pad according to an embodiment of the present invention may comprise forming a polishing layer comprising the polishing sheet.

In addition, the mechanical strength of a polishing layer and the physical properties of a polishing pad may be adjusted by adjusting the size and formation density of a pattern formed on the polishing sheet. Specifically, as the size of the pattern of the polishing sheet increases and the formation density increases, the physical properties (e.g., hardness) of the polishing pad can be further reduced. As the size of the pattern of the polishing sheet decreases and the formation density decreases, the physical properties (e.g., hardness) of the polishing pad can be further heightened. The size and formation density of a pattern of the polishing sheet are adjusted by, for example, adjusting the size, spacing, location, shape, and the like of the pattern when the pattern is formed in the process for preparing a polishing sheet, whereby the mechanical strength of a polishing layer and the physical properties of a polishing pad can be freely adjusted for each desired region.

The polishing layer may comprise a polishing surface and may further comprise other types of materials, resins, fibers, sheets, films, or the like, in addition to the polishing surface, to enhance physical properties such as mechanical strength, but it is not limited thereto. In addition, other types of materials, resins, sheets, films, or the like employed in the polishing layer may comprise those commonly used as long as they do not impair the object of the present invention, but they are not limited thereto.

In addition, the polishing layer comprises a polishing surface alone.

Thereafter, a step of forming a cushion layer on one side of the polishing layer may be carried out.

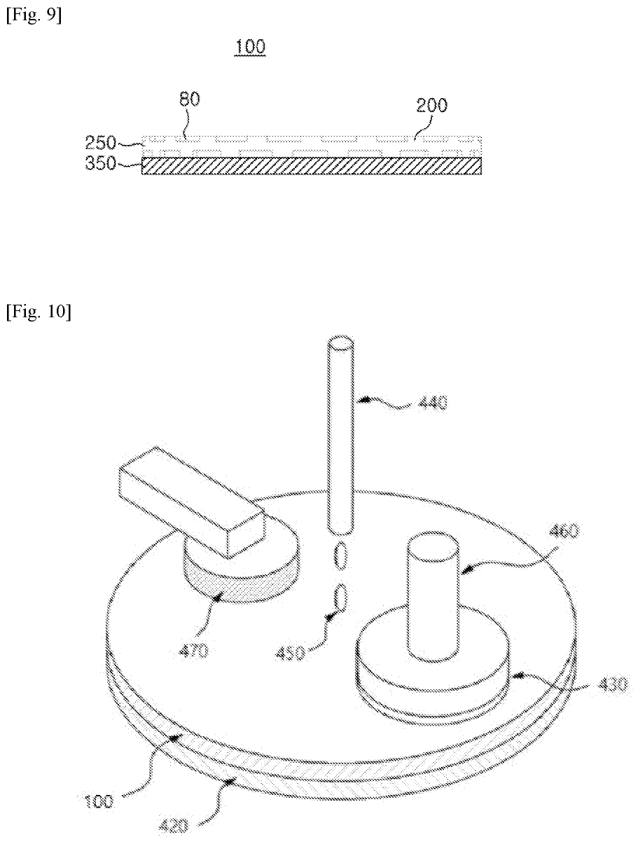

Specifically, referring to FIG. 9, the polishing pad (100) according to an embodiment of the present invention may comprise a polishing layer (250) comprising the polishing sheet (200) and a cushion layer (350). In addition, the polishing sheet (200) may comprise a pattern (second pattern) (80) induced on the surface of the polishing sheet as a polymer sheet on which a pattern (first pattern) has been formed is wound.

In addition, the polishing pad (100) may further comprise an adhesive layer (now shown) between the polishing layer (250) and the cushion layer (350).

For example, as an adhesive layer is interposed between the polishing layer (250) and the cushion layer (350), the polishing layer (250) and the cushion layer (350) may be laminated via a heat-sealing adhesive.

Specifically, the heat-sealing adhesive is applied on one side of the polishing layer (250), and the heat-sealing adhesive is applied on the surface of the cushion layer (350) to be in contact with the polishing layer (250). The polishing layer (250) and the cushion layer (350) are laminated such that the sides to which the heat-sealing adhesive has been applied come into contact, and the two layers may be fused using a pressure roller.

The cushion layer (350) serves to support the polishing layer (250) and to absorb and disperse an impact applied to the polishing layer (250). Thus, it is possible to minimize damage and defects to an object to be polished during the polishing process using the polishing pad (100).

The cushion layer (350) may comprise a nonwoven fabric or a suede, but it is not limited thereto.

In an embodiment, the cushion layer (350) may be a resin-impregnated nonwoven fabric. The nonwoven fabric may be a fibrous nonwoven fabric comprising one selected from the group consisting of a polyester fiber, a polyamide fiber, a polypropylene fiber, a polyethylene fiber, and combinations thereof.

The resin impregnated in the nonwoven fabric may comprise a polyurethane resin, a polybutadiene resin, a styrene-butadiene copolymer resin, a styrene-butadiene-styrene copolymer resin, an acrylonitrile-butadiene copolymer resin, a styrene-ethylene-butadiene-styrene copolymer resin, a silicone rubber resin, a polyester-based elastomer resin, a polyamide-based elastomer resin, and combinations thereof

[Process for Preparing a Semiconductor Device]

According to an embodiment of the present invention, there is provided a process for preparing a semiconductor device using the polishing sheet prepared by the above process.

The process for preparing a semiconductor device according to an embodiment of the present invention may comprise providing a polishing pad comprising a polishing layer comprising a polishing sheet and a cushion layer; and relatively rotating the polishing surface of the polishing layer and the surface of an object to be polished while they are in contact with each other to polish the object to be polished, wherein the polishing sheet may be prepared by a step comprising (1) preparing a polymer sheet comprising a polymer resin; (2) forming a pattern on the surface of the polymer sheet; (3) winding the patterned polymer sheet to form a wound roll in a cylindrical shape; and (4) cutting the wound roll in a direction perpendicular to the center line.

First, in the process for preparing a semiconductor device, the processes for preparing the polishing sheet and the polishing pad are as described above.

For example, a polishing pad prepared by forming a polishing layer using a polishing sheet and forming a cushion layer on one side of the polishing layer may be used in the process for preparing a semiconductor device.

The type of the cushion layer and the step of forming it are as described above. The process for preparing a semiconductor device comprises relatively rotating the polishing surface of the polishing layer and the surface of an object to be polished while they are in contact with each other to polish the object to be polished.

FIG. 10 schematically illustrates the process for preparing a semiconductor device according to an embodiment.

Referring to FIG. 10, once the polishing pad (100) according to an embodiment is attached to a platen (420), a semiconductor substrate (430) as an object to be polished is disposed on the polishing pad (100). In such an event, the surface of the semiconductor substrate (430) to be polished is in direct contact with the polishing surface of the polishing pad (100). A polishing slurry (450) may be sprayed through a nozzle (440) on the polishing pad for polishing. The flow rate of the polishing slurry (450) supplied through the nozzle (440) may be selected according to the purpose within a range of about 10 cm³/minute to about 1,000 cm³/minute. For example, it may be about 50 cm³/minute to about 500 cm³/minute, but it is not limited thereto.

Thereafter, the semiconductor substrate (430) and the polishing pad (100) rotate relatively to each other, so that the surface of the semiconductor substrate (430) is polished. In such an event, the rotation direction of the semiconductor substrate (430) and the rotation direction of the polishing pad (100) may be the same direction or opposite directions. The rotation speeds of the semiconductor substrate (430) and the polishing pad (100) may each be selected according to the purpose within a range of about 10 rpm to about 500 rpm. For example, it may be about 30 rpm to about 200 rpm, but it is not limited thereto.

The semiconductor substrate (430) mounted on the polishing head (460) is pressed against the polishing surface of the polishing pad (100) at a predetermined load to be in contact therewith, and the surface thereof may then be polished. The load applied to the polishing surface of the polishing pad (100) through the surface of the semiconductor substrate (430) by the polishing head (460) may be selected according to the purpose within a range of about 1 gf/cm² to about 1,000 gf/cm². For example, it may be about 10 gf/cm² to about 800 gf/cm², but it is not limited thereto. In an embodiment, the semiconductor substrate (430) as an object to be polished may comprise an oxide layer, a tungsten layer, or a composite layer thereof. Specifically, the semiconductor substrate (430) may comprise an oxide layer, a tungsten layer, or a composite layer of an oxide layer and a tungsten layer. The composite layer of an oxide layer and a tungsten layer may be a multilayer film in which the tungsten layer is laminated on one side of the oxide layer or may be a single-layer film in which an oxide region and a tungsten region are mixed in a single layer. As the object to be polished has such a film substance, a semiconductor device fabricated according to the process for preparing a semiconductor device may have excellent flatness and circuit characteristics.

In an embodiment, the process for preparing a semiconductor device may further comprise, in the step of polishing the object to be polished, supplying any one of a slurry for polishing an oxide layer and a slurry for polishing a tungsten layer; or sequentially supplying the slurry for polishing an oxide layer and the slurry for polishing a tungsten layer to the polishing surface.

For example, if the semiconductor substrate as an object to be polished comprises an oxide layer, the process for preparing a semiconductor device may comprise supplying a slurry for polishing an oxide layer. If the semiconductor substrate comprises a tungsten layer, the process for preparing a semiconductor device may comprise supplying a slurry for polishing a tungsten layer. If the semiconductor substrate comprises a composite layer of an oxide layer and a tungsten layer, the process for preparing a semiconductor device may comprise sequentially supplying a slurry for polishing an oxide layer and a slurry for polishing a tungsten layer to the polishing surface. Here, depending on the process, the slurry for polishing an oxide layer may be supplied first and then the slurry for polishing a tungsten layer may be supplied later, or the slurry for polishing a tungsten layer may be supplied first and then the slurry for polishing an oxide layer may be supplied later.

In an embodiment, in order to maintain the polishing surface of the polishing pad (100) in a state suitable for polishing, the process for preparing a semiconductor device may further comprise processing the polishing surface of the polishing pad (100) with a conditioner (470) simultaneously with polishing the semiconductor substrate (430).

As a polishing sheet prepared by the above preparation process is used in the process for preparing a semiconductor device according to an embodiment, a semiconductor device of excellent quality can be efficiently fabricated by controlling the size and distribution ratio of a fine and uniform pattern at a desired location.

1. A process for preparing a polishing sheet, which comprises:
(1) preparing a polymer sheet comprising a polymer resin;
(2) forming a pattern on the surface of the polymer sheet;
(3) winding the patterned polymer sheet to form a wound roll in a cylindrical shape; and
(4) cutting the wound roll in a direction perpendicular to the center line.

2. The process for preparing a polishing sheet of claim 1, wherein, in step (1), the preparation of a polymer sheet comprises:
(1-1) heating and melting the polymer resin;
(1-2) extruding the molten polymer resin to form a sheet; and
(1-3) adjusting the thickness of the sheet at least once using a roller.

3. The process for preparing a polishing sheet of claim 2, which, in step (1-3), further comprises subjecting the sheet to a first thermal treatment at a temperature between the melting temperature (Tm) and the glass transition temperature (Tg) of the polymer resin before the use of the roller.

4. The process for preparing a polishing sheet of claim 1, wherein, is step (1), the polymer resin comprises a thermoplastic polymer resin.

5. The process for preparing a polishing sheet of claim 4, wherein the thermoplastic polymer resin comprises at least one selected from the group consisting of polyurethane-based resins, polyethylene-based resins, polypropylene-based resins, polystyrene-based resins, acrylic-based resins, vinylidene chloride-based resins, vinyl chloride-based resins, fluorine-based resins, polyvinyl acetate-based resins, polyamide-based resins, polycarbonate-based resins, acetal-based resins, polyphenylene oxide-based resins, polyester-based resins, polysulfone-based resins, and polyimide-based resins.

6. The process for preparing a polishing sheet of claim 3, wherein, in step (2), the formation of a pattern comprises forming irregularities, grooves, pores, or penetrating holes on the surface of the polymer sheet using a punching roller, a laser pulse, or both.

7. The process for preparing a polishing sheet of claim 6, wherein, in step (2), the formation of a pattern is carried out using a punching roller, and
the process further comprises subjecting the polymer sheet to a second thermal treatment at a temperature between the melting temperature (Tm) and the glass transition temperature (Tg) of the polymer resin before the formation of a pattern.

8. The process for preparing a polishing sheet of claim 7, which, is step (3), further comprises gelating the polymer sheet before the polymer sheet on which a pattern has been formed is wound,
wherein the gelation is carried out by a third thermal treatment at a temperature between the melting temperature (Tm) and the glass transition temperature (Tg) of the polymer resin.

9. The process for preparing a polishing sheet of claim 1, wherein, before the polymer sheet on which a pattern has been formed is wound in step (3), an adhesive layer is attached to one side of the polymer sheet, or an adhesive spray is injected, to be wound together.

10. The process for preparing a polishing sheet of claim 8, which, in step (3), further comprises subjecting the wound roll to a fourth thermal treatment at a temperature equal to, or lower than, the melting temperature (Tm) of the polymer resin.

11. The process for preparing a polishing sheet of claim 1, wherein, in step (4), the cutting step is carried out at room temperature using at least one selected from the group consisting of a diamond blade, a wire saw, and a multi wire saw.

12. The process for preparing a polishing sheet of claim 1, wherein the polishing sheet has a circular longitudinal cross-section, a diameter of 300 mm or more, a thickness of 1.5 mm to 5 mm, and a hardness of 10 Shore D to 90 Shore D.

13. The process for preparing a polishing sheet of claim 6, wherein, as the polymer sheet on which a pattern has been formed is wound, an induced pattern is formed on the surface of the polishing sheet, and
the total area of the induced pattern is 30% to 70% of the total surface area of the polishing sheet.

14. A process for preparing a polishing pad, which comprises:
providing a polishing sheet; and
forming a cushion layer on one side of a polishing layer comprising the polishing sheet,
wherein the step of providing a polishing sheet comprises:
(1) preparing a polymer sheet comprising a polymer resin;
(2) forming a pattern on the surface of the polymer sheet;
(3) winding the patterned polymer sheet to form a wound roll in a cylindrical shape; and
(4) cutting the wound roll in a direction perpendicular to the center line.
